(19) United States
(12) Patent Application Publication
(10) Pub. No.: US 2016/0291333 A1
(43) Pub. Date: Oct. 6, 2016

(54) Liquid Crystal Lens and Three-Dimensional Display Device

(71) Applicant: SUPERD CO., LTD., Shenzhen, Guangdong (CN)

(72) Inventors: Zhaoyu Chen, Shenzhen, Guangdong (CN); Honglei Wang, Shenzhen, Guangdong (CN); Xiaoda Gong, Shenzhen, Guangdong (CN)

(21) Appl. No.: 14/392,349

(22) PCT Filed: Jul. 17, 2015
(86) PCT No.: PCT/CN2015/084305

§ 371 Date: Dec. 23, 2015

(30) Foreign Application Priority Data
Jul. 18, 2014 (CN) 201410344728.6
Apr. 30, 2015 (CN) 201510217311.8
Apr. 30, 2015 (CN) 201510218953.X

(51) Int. Cl. G02B 27/22; G02F 1/1333; G02F 1/29; G02F 1/1343

(52) U.S. Cl. CPC G02B 27/2214; G02F 1/134309; G02F 1/133345; G02F 1/292

(57) ABSTRACT

The present invention belongs to the technical field of three-dimensional display, and provides a liquid crystal lens. The liquid crystal lens includes a first substrate and a second substrate which are arranged oppositely, wherein a plurality of first electrodes are arranged on the first substrate, the first electrodes are arranged at intervals, when the liquid crystal lens is used for three-dimensional display, a plurality of liquid crystal lens units with the same structure are formed between the first substrate and the second substrate, two adjacent liquid crystal lens units share one first electrode, a plurality of second electrodes are arranged on one side of the second substrate facing to the first substrate, the second electrodes are arranged at intervals, an opening portion is formed between two adjacent second electrodes.

### CROSS REFERENCE OF RELATED APPLICATION

The present application claims the priority of Chinese Application No. 201410344728.6, filed in China on Jul. 18, 2014, and claims the priority of Chinese Application No. 201510217311.8 and 201510218953.X, filed in China on Apr. 30, 2015, the entire contents of which are herein incorporated by reference.

### FIELD OF THE INVENTION

The present disclosure belongs to the technical field of three-dimensional display, and in particular relates to a liquid crystal lens and a three-dimensional display device including the same.

### BACKGROUND OF THE INVENTION

In a three-dimensional display device adopting a liquid crystal lens to achieve three-dimensional display, a common electrode and a plurality of driving electrodes are respectively arranged on two substrates on both sides of a liquid crystal layer, corresponding driving voltages are applied to the driving electrodes and a common voltage is applied to the common electrode to form a vertical electric field with unequal electric field intensities between the two substrates, so as to drive liquid crystal molecules to arrange to form a variable-focus liquid crystal lens. Therefore, the refractive index distribution of the liquid crystal lens would be correspondingly changed just by controlling the voltage distribution of the driving electrodes, so as to control the distribution of light emitted by a display panel to achieve free three-dimensional display.

FIG. 1 is a schematic structural diagram of a three-dimensional display device provided by the prior art. The three-dimensional display device includes a display panel 1′ and a liquid crystal lens 2′, the liquid crystal lens 2′ is arranged on the emergent side of the display panel 1′, light emitted by the display panel 1′ enters the left and right eyes of a viewer through the liquid crystal lens 2′ respectively. The liquid crystal lens 2′ includes a first substrate 21′ and a second substrate 22′ which are arranged oppositely, and a liquid crystal layer sandwiched between the first substrate 21′ and the second substrate 22′, a plurality of first electrodes 23′ which are arranged at intervals are arranged on the first substrate 21′, and second electrodes 24′ are arranged on the second substrate 22′. When the three-dimensional display device is used for 3D display, an electric field with unequal electric field intensities is produced between the first substrate 21′ and the second substrate 22′ by applying required voltages to the plurality of first electrodes 23′ and the second electrodes 24′, and the electric field drives liquid crystal molecules 25′ in the liquid crystal layer to deflect. Due to the unequal electric field intensities, the deflecting degrees of the liquid crystal molecules 25′ driven by the electric field are different. Accordingly, the refractive index of the liquid crystal lens 2′ is correspondingly changed by controlling the voltage distribution on the plurality of first electrodes 23′, so that the light emitted by the display panel 1′ is controlled to realize three-dimensional display.

When the three-dimensional display device is used for 3D display, liquid crystal lens units arranged in an array manner are formed between the first substrate 21′ and the second substrate 22′, and each liquid crystal lens unit has the same structure. FIG. 2 merely shows a first liquid crystal lens unit L1′ and a second liquid crystal lens unit L2′ which are adjacent to each other, the first liquid crystal lens unit L1′ corresponds to two first electrodes 23′, and the second liquid crystal lens unit L2′ corresponds to two first electrodes 23′. It can be known according to the working principle of the liquid crystal lens 2′ that, a first driving voltage is applied to the first electrodes 23′, a second driving voltage is applied to each second electrode 24′, thus an electric field with maximum electric field intensity is formed at the first electrodes 23′, the liquid crystal molecules 25′ at the first electrodes 23′ are vertically distributed under the drive of the electric field, and the electric field is weaker as being farther away from the first electrodes 23′, namely the liquid crystal molecules 25′ would gradually become horizontal.

To meet the imaging requirements, the voltage applied to the edge of the first liquid crystal lens unit L1′ is the maximum, the liquid crystal molecules 25′ nearby the first electrode 23′ at the edge of the first liquid crystal lens unit L1′ are basically distributed in the vertical direction, and the voltage is smaller as being closer to the center of the first liquid crystal lens unit L1′, thus the liquid crystal molecules 25′ would gradually become horizontal. In each liquid crystal lens unit, due to the symmetrical voltage distribution, the refractive indexes of the liquid crystal molecules 25′ change gradually with the change of the electric field intensity, and thus the second liquid crystal lens unit L2′ has better optical imaging property.

According to a gradient lens optical path difference formula of refractive index

$$Δ nd = \frac{{D}^{2}}{8 f} ,$$

wherein, Δn=nₘₐₓ−n(r)=nₑ−nᵣ, nₑ refers to an extraordinary refractive index of the liquid crystal molecules 25′, and the refractive index n(r) changes on different positions as a function of a position r. In FIG. 2, the liquid crystal molecules 25′ on the first electrodes 23′ at the edges of the first liquid crystal lens unit L1′ and the second liquid crystal lens unit L2′ are vertical, n(r)=nₒ, while the long axes of the liquid crystal molecules 25′ nearby the center of each liquid crystal lens unit are horizontal, n(r)=nₑ. D refers to the size of the opening of each liquid crystal lens unit, f refers to the focal length of each liquid crystal lens unit, and d refers to the thickness of the liquid crystal layer. Meanwhile, to reduce the crosstalk caused by the liquid crystal lens 2′ during the three-dimensional display to prevent a left-eye image from entering the right eye and a right-eye image from entering the left eye, the optical path difference distribution of the liquid crystal lens 2′ needs to be matched with that of a standard parabolic lens.

In the liquid crystal lens 2′ as shown in FIG. 2, each second electrode 24′ is a planar electrode. FIG. 3 is a comparison diagram of the optical path difference distribution of the first liquid crystal lens unit L1′ and the second liquid crystal lens unit L2′ and the ideal optical path difference distribution of the parabolic lens. It can be seen from FIG. 3 that, a first electrode 23′ is shared at the edges of the first liquid crystal lens unit L1′ and the second liquid crystal lens unit L2′ which are adjacent to each other. When the three-dimensional display device is used for 3D display, the electric field intensity at the junction of the first liquid crystal lens unit L1′ and the second liquid crystal lens unit L2′ is changed relatively violently, so that the optical path difference herein greatly fluctuates, the optical path difference distribution of the liquid crystal lens 2′ herein obviously deviates from the ideal optical path difference distribution of the parabolic lens, and therefore the imaging property of the liquid crystal lens 2′ herein is affected. Accordingly, the optical path at the boundary of the liquid crystal lens unit greatly deviates from that of the standard parabolic lens. When the liquid crystal lens 2′ is applied to the 3D display technology, the deviation increases the crosstalk of the three-dimensional display device, and affects the picture quality of three-dimensional display.

As shown in FIG. 4, the prior art discloses a liquid crystal lens and a driving method thereof, and a three-dimensional display device. The liquid crystal lens 20 includes a liquid crystal lens unit L10 and a liquid crystal lens unit L20 which have the same structure, each liquid crystal lens unit includes a first substrate 210 and a second substrate 220 which are arranged oppositely. A number of first electrodes 230 are arranged on the first substrate 210, a planar electrode 240 is arranged on one side of the second substrate 220 facing to the first substrate 210, and a number of second electrodes 250 are arranged on the planar electrode 240. The planar electrode 240 is grounded as a common electrode, and each second electrode 250 is applied with a negative voltage. Different driving voltages are applied to the first electrodes 230, the planar electrode 240 and the second electrodes 250 respectively, so that the liquid crystal lens 20 is complex in manufacturing process, fussy in driving design and difficult to implement in the industry.

### SUMMARY OF THE INVENTION

The aim of the present disclosure is to provide a liquid crystal lens and a three-dimensional display device, so as to solve one or more of the above technical problems caused by the limitation and defects of the prior art.

The present disclosure is realized in such a way that, a liquid crystal lens is provided, including a first substrate and a second substrate which are arranged oppositely, and liquid crystal molecules sandwiched between the first substrate and the second substrate, wherein the first substrate is provided with a plurality of first electrodes, the first electrodes are arranged at intervals, when the liquid crystal lens is used for three-dimensional display, a plurality of liquid crystal lens units with the same structure and distributed in an array manner are formed between the first substrate and the second substrate, and two adjacent liquid crystal lens units share one first electrode, wherein a plurality of second electrodes are arranged on one side of the second substrate facing to the first substrate, the extension direction of the second electrodes is parallel to the extension direction of the first electrodes, the second electrodes are arranged at intervals, an opening portion is formed between two adjacent second electrodes, the central line of the opening portion is on the same straight line as the central line of the corresponding first electrode at the edge of the liquid crystal lens unit.

When the liquid crystal lens provided by the present disclosure is used for 3D display, a plurality of liquid crystal lens units with the same structure are formed between the first substrate and the second substrate, and each liquid crystal lens unit corresponds to a second electrode. The pitch of the liquid crystal lens unit is greater than the width of each second electrode, and the central line of the second electrode and the central line of the corresponding liquid crystal lens unit are on the same straight line, when the first driving voltage is applied to the first electrode, as the gap formed between two adjacent second electrodes is opposite to the first electrode at the edge of the liquid crystal lens unit, the electric field intensity at the edge of the liquid crystal lens unit is adjusted, the deflecting degrees of the liquid crystal molecules nearby the first electrode are improved, a smoother phase retardation quantity is presented, the crosstalk at the junction of two adjacent liquid crystal lens units is obviously reduced, and the three-dimensional display effect and the viewing comfortableness are improved.

Another aim of the present disclosure is to provide a three-dimensional display device, including a display panel and the above liquid crystal lens, wherein the liquid crystal lens is arranged on the emergent side of the display panel.

According to the three-dimensional display device provided by the present disclosure, light emitted by the display panel is adjusted by the liquid crystal lens units to present three-dimensional images, so that crosstalk caused by the liquid crystal lens is eliminated, and the three-dimensional display effect and the viewing comfortableness are improved.

### BRIEF DESCRIPTION OF THE DRAWINGS

FIG. 1 is a schematic structural diagram of a three-dimensional display device provided by the prior art;

FIG. 2 is a schematic structural diagram of a liquid crystal lens provided by the prior art;

FIG. 3 is a comparison diagram of the optical path difference distribution of the liquid crystal lens provided by the prior art and the ideal optical path difference distribution of a parabolic lens;

FIG. 4 is another schematic structural diagram of the liquid crystal lens provided by the prior art;

FIG. 5 is a schematic structural diagram of a liquid crystal lens provided by embodiment 1 of the present disclosure;

FIG. 6 is a state schematic diagram of the liquid crystal lens provided by embodiment 1 of the present disclosure during three-dimensional display;

FIG. 7 is a schematic diagram of the optical path difference distribution of the liquid crystal lens provided by embodiment 1 of the present disclosure;

FIG. 8 is a schematic structural diagram of a first electrode provided by embodiment 1 of the present disclosure;

FIG. 9 is a schematic structural diagram of a liquid crystal lens provided by embodiment 2 of the present disclosure;

FIG. 10 is a schematic diagram of the optical path difference distribution of the liquid crystal lens provided by embodiment 2 of the present disclosure;

FIG. 11 is a schematic structural diagram of a liquid crystal lens provided by embodiment 3 of the present disclosure;

FIG. 12 is a schematic structural diagram of a liquid crystal lens provided by embodiment 4 of the present disclosure.

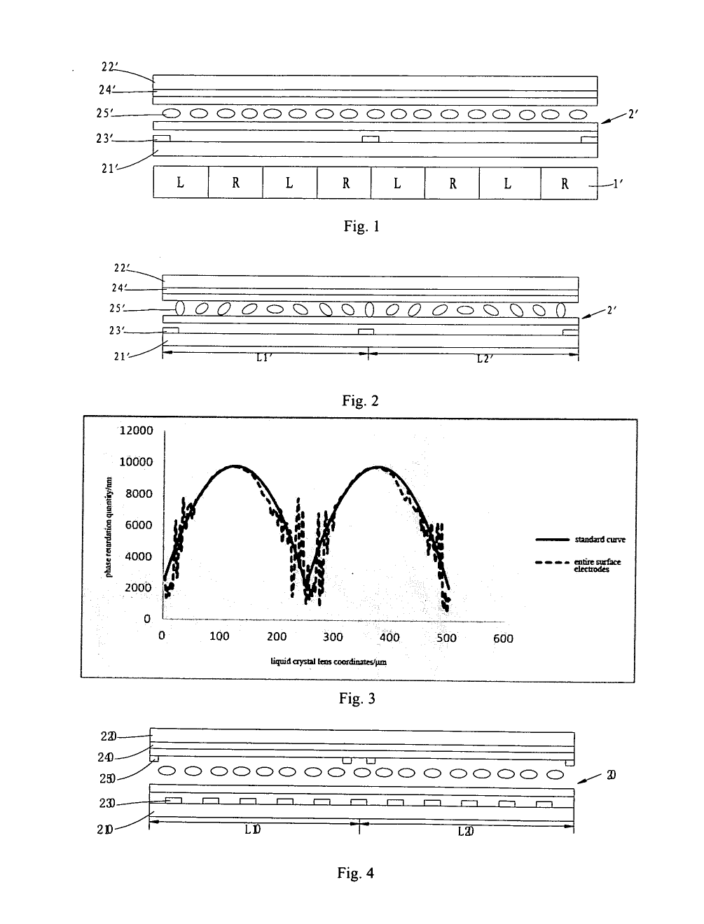

### DETAILED DESCRIPTION OF THE EMBODIMENTS

To make the to-be-solved technical problems, technical schemes and beneficial effects of the present disclosure more clear, the present disclosure will be further described in detail below in combination with the accompanying drawings and the embodiments. It should be understood that, the specific embodiments described herein are merely used for interpreting the present disclosure, rather than limiting the present disclosure.

### Embodiment 1

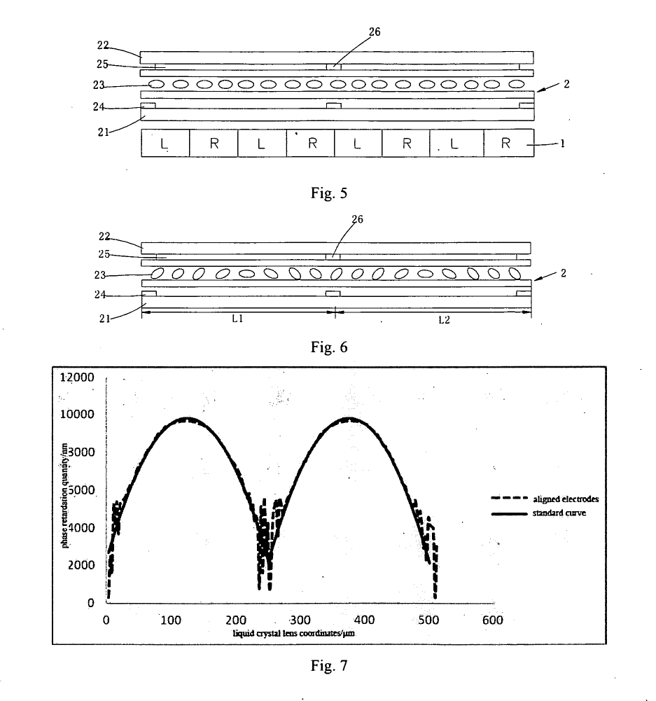

As shown in FIG. 5 and FIG. 6, the present invention provides a liquid crystal lens 2, including a first substrate 21 and a second substrate 22 which are arranged oppositely, and liquid crystal molecules 23 sandwiched between the first substrate 21 and the second substrate 22, wherein a plurality of first electrodes 24 are arranged on the first substrate 21, the first electrodes 24 are arranged at intervals, and a plurality of second electrodes 25 are arranged on one side of the second substrate 22 facing to the first substrate 21. When the liquid crystal lens 2 is used for three-dimensional display, a first voltage is applied to the first electrodes 24, a second voltage is applied to the second electrodes 25, and a first electric field with unequal electric field intensities is formed between the first substrate 21 and the second substrate 22 by the potential difference between the first voltage and the second voltage. The first electric field drives the liquid crystal molecules 23 to deflect, a plurality of liquid crystal lens units with the same structure and arranged in an array manner are formed between the first substrate 21 and the second substrate 22, and a liquid crystal lens unit L1 and a liquid crystal lens unit L2 which are adjacent to each other share one first electrode 23. FIG. 6 only shows the liquid crystal lens unit L1 and the liquid crystal lens unit L2. The liquid crystal lens unit L1 and the liquid crystal lens unit L2 have the same structure, the liquid crystal lens unit L1 and the liquid crystal lens unit L2 have gradually-changed refractive indexes, so that the optical path of the light can be changed to present three-dimensional images. In this embodiment, because the liquid crystal lens unit L1 and the liquid crystal lens unit L2 have the same structure, only the liquid crystal lens unit L1 is described and the repeated description of the liquid crystal lens unit L2 is omitted, when the liquid crystal lens unit is mentioned. The description below will follow the same and will not be repeated again.

The second electrodes 25 are arranged at intervals, an opening portion 26 is formed in the gap between two adjacent second electrodes 25, and the central line of the opening portion 26 is on the same straight line as the central line of the corresponding first electrode 24 at the edge of the liquid crystal lens unit L1, thereby ensuring that the opening portion 26 and the first electrode 24 at the edge of the liquid crystal lens unit L1 are arranged correspondingly. Since the opening portion 26 is provided with no conductive material, the electric field at the junction of the liquid crystal lens unit L1 and the liquid crystal lens unit L2 would not be changed sharply to result in large fluctuation of the optical path difference herein. Voltages are respectively applied to the first electrode 24 and the second electrode 25, and the optical path difference of the liquid crystal lens 2 coincides with that of the standard parabolic lens much better. When the liquid crystal lens 2 is used for three-dimensional display, the crosstalk can be reduced obviously, and the quality of three-dimensional image display is improved. The electric field curve at the opening portion 26 approaches the area having a conductive material in a relatively mild state, so as to optimize the distribution of the electric field intensity at the edge of the liquid crystal lens unit L1, and improve the deflecting degrees of the liquid crystal molecules 23 nearby the first electrode 24 at the edge of the liquid crystal lens unit L1, and the optical path difference distribution curve of the liquid crystal lens 2 presents a smoother phase retardation quantity. Thus, the electric field change at the junction of the liquid crystal lens unit L1 and the liquid crystal lens unit L2 is improved to a certain extent and approaches the second electrode 25 in a relatively mild state, such that the relatively great fluctuation of the optical path difference herein caused by the electric field change is avoided, the crosstalk at the junction of the adjacent liquid crystal lens unit L1 and liquid crystal lens unit L2 is obviously reduced, and the three-dimensional display effect and the viewing comfortableness are improved. Meanwhile, the second driving voltage is applied to the second electrodes 25, so that it is ensured that an electric field with unequal electric field intensities is formed between the first substrate 21 and the second substrate 22, and the liquid crystal molecules 23 deflect under the action of the electric field, to meet the requirement for applying the liquid crystal lens 2 to three-dimensional display. When the liquid crystal lens 2 provided by the embodiment of the utility model is used for three-dimensional display, only the first voltage is applied to the first electrode 24, and the second voltage is applied to the second electrode 25, so that the liquid crystal molecules 23 in the liquid crystal lens 2 deflect to form the liquid crystal lens unit L1 with gradually-changed refractive index, and the liquid crystal lens is simple in operation and easy to implement.

As shown in FIG. 7, by adopting the liquid crystal lens 2 provided by this embodiment, the opening portion 26 is formed at the second substrate 22, the opening portion 26 is provided with no conductive material, when the liquid crystal lens 2 is used for three-dimensional display, the distribution of the electric field intensity at the edge of the liquid crystal lens unit L1 is optimized, the deflecting degrees of the liquid crystal molecules 23 nearby the first electrode 24 at the edge of the liquid crystal lens unit L1 are improved, and the optical path difference distribution curve of the liquid crystal lens 2 presents a smoother phase retardation quantity, the crosstalk at the junction of the liquid crystal lens unit L1 and the liquid crystal lens unit L2 is obviously reduced, the three-dimensional display effect and the viewing comfortableness are improved, the optical path difference distribution at the junction of the adjacent liquid crystal lens unit L1 and liquid crystal lens unit L2 is obviously improved. The optimized optical path difference distribution approaches an ideal parabola, so that the crosstalk produced when the three-dimensional display device adopting the liquid crystal lens 2 is used for three-dimensional display is improved, and thus the three-dimensional display effect and the viewing comfortableness are improved.

In this embodiment, as shown in FIG. 6, the liquid crystal lens unit L1 corresponds to one second electrode 25 and at least two first electrodes 24, and when the liquid crystal lens 2 is used for three-dimensional display, the electric field among one second electrode 25 and at least two first electrodes 24 drives the liquid crystal molecules 23 to deflect, thereby forming a regular liquid crystal lens unit L1. Since the liquid crystal lens unit L1 and the liquid crystal lens unit L2 are arranged in sequence, and the opening portion 26 is formed between two adjacent second electrodes 25, when the liquid crystal lens 2 is used for three-dimensional display, voltages are respectively applied to the first electrode 24 and the second electrode 25, the opening portion 26 formed between the two adjacent second electrodes 25 is opposite to the first electrode 24 at the edge of the liquid crystal lens unit L1, so that the distribution of the electric field intensity at the edges of the liquid crystal lens unit L1 and the liquid crystal lens unit L2 is optimized, the deflecting degrees of the liquid crystal molecules 23 nearby the first electrode 24 at the edge of the liquid crystal lens unit L1 are improved, a smoother phase retardation quantity is presented, the crosstalk at the junction of the adjacent liquid crystal lens unit L1 and liquid crystal lens unit L2 is reduced, and the three-dimensional display effect and the viewing comfortableness are improved. Meanwhile, to ensure that three-dimensional images can be normally presented when the liquid crystal lens 2 is used for three-dimensional display, the distance between the two adjacent second electrodes 25 cannot be too large, to avoid affecting the normal display of the liquid crystal lens 2.

In this embodiment, one liquid crystal lens unit L1 corresponds to one second electrode 25, the width of the second electrode 25 is set to be less than the pitch of the liquid crystal lens unit L1, and the pitch of the liquid crystal lens unit L1 refers to the distance between the central lines of two first electrodes 24 at the edge of the liquid crystal lens unit L1. The central line of the liquid crystal lens unit L1 is on the same straight line as the central line of the corresponding second electrode 25, in this case, the electric field formed between the second electrode 25 and the first electrode 24 drives the liquid crystal molecules 23 to deflect regularly, ensuring that the liquid crystal lens unit L1 with the same structure can be presented when the liquid crystal lens 2 is used for three-dimensional display.

Since the width of the second electrode 25 is less than the pitch of the liquid crystal lens unit L1, and the opening portion 26 is formed between the liquid crystal lens unit L1 and the liquid crystal lens unit L2, the width of the opening portion 26 can be set to be less than the width of the first electrode 24 at the edge of the liquid crystal lens unit L1, in this way, the second electrode 25 and the first electrode 24 have a relatively superposed portion, so that the distribution of the electric field intensity at the junction of the liquid crystal lens unit L1 and the liquid crystal lens unit L2 is optimized, the deflecting degrees of the liquid crystal molecules 23 nearby the first electrode 24 at the edge of the liquid crystal lens unit L1 are improved, the optical path difference distribution curve of the liquid crystal lens 2 presents a smoother phase retardation quantity, the crosstalk at the junction of the adjacent liquid crystal lens unit L1 and liquid crystal lens unit L2 is reduced, and the three-dimensional display effect and the viewing comfortableness are improved.

Of course, the width of the opening portion 26 can also be set to be greater than the width of the first electrode 24 at the edge of the liquid crystal lens unit L1, namely the second electrode 25 and the first electrode 24 do not coincide with each other at all, and no conductive material is arranged at the position of the second substrate 22 corresponding to the first electrode 24 at the edge of the liquid crystal lens unit L1 at all, therefore, the electric field curve at the opening portion 26 approaches the area having a conductive material in a relatively mild state, the distribution of the electric field intensity at the edge of the liquid crystal lens unit L1 is optimized, the deflecting degrees of the liquid crystal molecules 23 nearby the first electrode 24 at the edge of the liquid crystal lens unit L1 are improved, and a smoother phase retardation quantity is presented.

It can be understood that, the width of the opening portion 26 can also be set to be equal to the width of the first electrode 24 at the edge of the liquid crystal lens unit L1, namely the second electrode 25 and the first electrode 24 do not coincide with each other, the optical path fluctuation produced at the junction of the liquid crystal lens unit L1 and the liquid crystal lens unit L2 can also be inhibited, so that the electric field curve at the junction of the liquid crystal lens unit L1 and the liquid crystal lens unit L2 approaches the second electrode 25 in a relatively mild state, the deviation of the optical path difference at the junction of the liquid crystal lens unit L1 and the liquid crystal lens unit L2 from that of the standard parabolic lens is reduced, the crosstalk at the junction of the adjacent liquid crystal lens unit L1 and liquid crystal lens unit L2 is improved, and thus the display quality of the liquid crystal lens 2 is improved.

As shown in FIG. 6, the liquid crystal lens unit L1 provided by this embodiment corresponds to one second electrode 25 and two first electrodes 24, since the liquid crystal lens unit L1 and the liquid crystal lens unit L2 are arranged in sequence, and the opening portion 26 is formed between two adjacent second electrodes 25, when the liquid crystal lens 2 is used for three-dimensional display, voltages are respectively applied to the first electrode 24 and the second electrode 25, and the opening portion 26 is provided with no conductive material, so that the electric field curve at the opening portion 26 approaches the area having a conductive material in a relatively mild state, the distribution of the electric field intensity at the edge of the liquid crystal lens unit L1 is optimized, the deflecting degrees of the liquid crystal molecules 23 nearby the first electrode 24 at the edge of the liquid crystal lens unit L1 are improved, and a smoother phase retardation quantity is presented. Thus, the electric field change at the junction of the liquid crystal lens unit L1 and the liquid crystal lens unit L2 approaches the second electrode 25 in a relatively mild state, and accordingly, the relatively great fluctuation of the optical path difference herein caused by the electric field change is avoided, the crosstalk at the junction of the adjacent liquid crystal lens unit L1 and liquid crystal lens unit L2 is obviously reduced, and the three-dimensional display effect and the viewing comfortableness are improved.

To better illustrate the liquid crystal lens 2 provided by this embodiment, during three-dimensional display, the crosstalk at the junction of the liquid crystal lens unit L1 and the liquid crystal lens unit L2 can be obviously reduced, and an experimental result will be illustrated below. Specifically, the liquid crystal lens unit L1 provided by this embodiment corresponds to one second electrode 25 and two first electrodes 24. The pitch of the liquid crystal lens unit L1 is set as 256 microns, optical path difference simulation is performed by using LC-MASTER software, and the obtained simulation data are processed by using MATLAB. The ordinary refractive index n₀ of each liquid crystal molecule 23 used in this simulation experiment is 1.524, and the extraordinary refractive index nₑ of the liquid crystal molecule 23 is 1.824. Both the thickness of the liquid crystal lens 2 and the width of the first electrode 24 are set as 30 microns, and main parameters including the driving voltages are unchanged in the simulation experiments of the liquid crystal lens 2′ (shown in FIG. 2) provided by the prior art and the liquid crystal lens 2 provided by this embodiment. FIG. 3 shows the simulation result of the liquid crystal lens 2′ provided by the prior art, wherein the curves in the figure include an optical path difference distribution curve of the liquid crystal lens 2′ provided by the prior art and an optical path difference distribution curve of the standard parabolic lens. It can be seen that, the optical path difference distribution curve at the junction of the two adjacent liquid crystal lens units L1′ and L2′ deviates greatly from the optical path difference distribution curve of the standard parabolic lens, and the deviation would lead to great crosstalk in practical 3D viewing. FIG. 7 shows the simulation result of the liquid crystal lens 2 provided by this embodiment, wherein the width of the second electrode 25 in this embodiment is set as 156 microns. It can be seen that, after the simulation data are processed, the optical path difference curve of the liquid crystal lens 2 provided by this embodiment and the optical path difference curve of the standard parabolic lens well coincide with each other, and the deviation of the optical path difference distribution at the junction of the liquid crystal lens unit L1 and the liquid crystal lens unit L2 from the optical path difference distribution curve of the standard parabolic lens is small, so that the optical path difference distribution curve fluctuation is greatly improved. Thus, the crosstalk is effectively reduced in the three-dimensional display process, and accordingly the viewing comfortableness is improved. Compared with the optical path difference distribution curve of the liquid crystal lens 2′ provided by the prior art, great improvement is made, the crosstalk at the junction of the liquid crystal lens unit L1 and the liquid crystal lens unit L2 is reduced, and the three-dimensional display effect and the viewing comfortableness are improved.

In this embodiment, the extension direction of the second electrode 25 is parallel to the extension direction of the first electrode 24, the extension direction of the first electrode 24 can be set to be parallel to the width direction of the first substrate 21, when the liquid crystal lens 2 is used for three-dimensional display, the first voltage is applied to the first electrode 24 and the second voltage is applied to the second electrode 25, so that liquid crystal lens units L1 arranged in an array manner are formed between the first substrate 21 and the second substrate 22, the first electrode 24 is processed on the first substrate 21 by adopting an etching process, and thus the operation is convenient. Of course, to solve a Moire pattern problem occurring when the liquid crystal lens 2 is used for three-dimensional display, the first electrodes 24 are arranged obliquely on the second substrate 22, since the extension direction of the second electrode 25 is parallel to the extension direction of the first electrode 24, the first electrode 24 and the second electrode 25 are arranged obliquely along a certain angle, the periodic interference of the liquid crystal lens 2 is improved, Moire patterns are weakened, and the display effect when the liquid crystal lens 2 is used for three-dimensional display is improved.

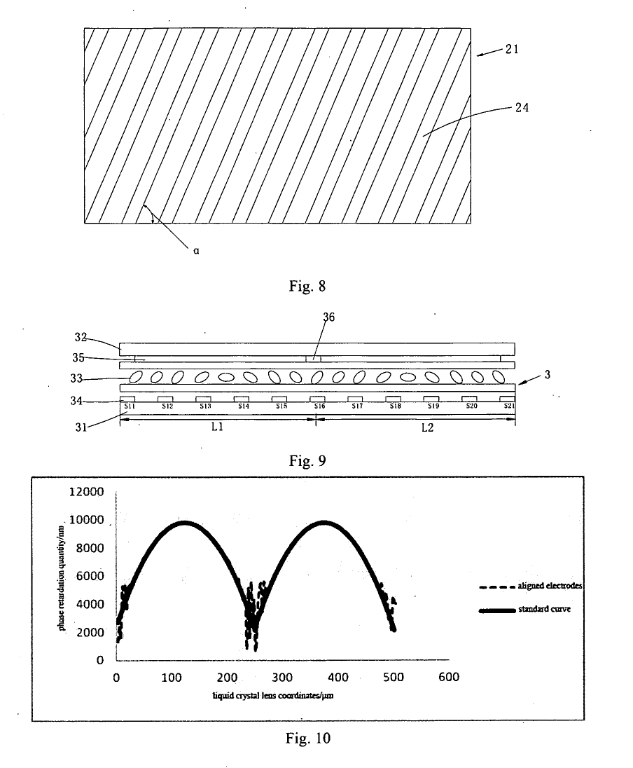

As shown in FIG. 8, to conveniently design the inclination angle of the first electrode 24, and ensure that the first electrode 24 and the second electrode 25 arranged obliquely would not affect the light splitting effect of the liquid crystal lens 2 and that the left eye image is sent to the left eye of the viewer and the right eye image is sent to the right eye of the viewer when the liquid crystal lens 2 is used for three-dimensional display, the extension direction of the first electrode 24 is set to intersect the arrangement direction of the first electrode 24 to form an included angle α, wherein 60°≦α≦80°. By setting the inclination angle of the first electrode 24 within this range, not only the Moire patterns are improved, but also such problems affecting three-dimensional display as crosstalk and the like are solved. The included angle α provided by this embodiment refers to an acute included angle formed by the inclination direction of the first electrode 24 and the arrangement direction of the first electrode 24, in this embodiment, the inclination direction of the first electrode 24 is rightward inclination, similarly, the inclination direction of the first electrode 24 can also be set as leftward inclination, and the included angle α is an acute angle sandwiched by the inclination direction of the first electrode 24 and the arrangement direction of the first electrode 24. In this embodiment, the first electrodes 24 are arranged on the first substrate 22 along the same direction, and the arrangement direction of the first electrodes 24 is the transverse direction of the first substrate 22. In this embodiment, for conveniently processing the first electrode 24, the first electrode 24 can be set as a strip electrode, and the cross section of the first electrode 24 along the extension direction of the first electrode 24 is rectangular, arched or serrated, so as to facilitate manufacturing and processing. In this embodiment, the selected shape of the first electrode 24 should satisfy that driving voltages are respectively applied to the first electrode 24 and the second electrode 25 to drive the liquid crystal molecules 23 to deflect to form the liquid crystal lens unit L1 when the liquid crystal lens 2 is used for three-dimensional display. Of course, the cross section of the first electrode 24 can also be in any other regular or irregular shapes, which all belong to the protection scope of the utility model. Definitely, the shape of the cross section of the first electrode 24 provided by this embodiment is only illustrative, and the first electrode 24 in the regular shape is processed more easily.

As shown in FIG. 5 and FIG. 6, similarly, for conveniently manufacturing and processing the second electrode 25, the second electrode 25 is set as a strip electrode, and the cross section of the second electrode 25 along the extension direction of the second electrode 25 is rectangular, arched or serrated. In this embodiment, the selected shape of the second electrode 25 should satisfy that driving voltages are respectively applied to the first electrode 24 and the second electrode 25 to drive the liquid crystal molecules 23 to deflect to form the liquid crystal lens unit L1 when the liquid crystal lens 2 is used for three-dimensional display. Of course, the cross section of the second electrode 25 can also be in any other regular or irregular shapes, which all belong to the protection scope of the utility model. Definitely, the shape of the cross section of the second electrode 25 provided by this embodiment is only illustrative, and the second electrode 25 in the regular shape is processed more easily.

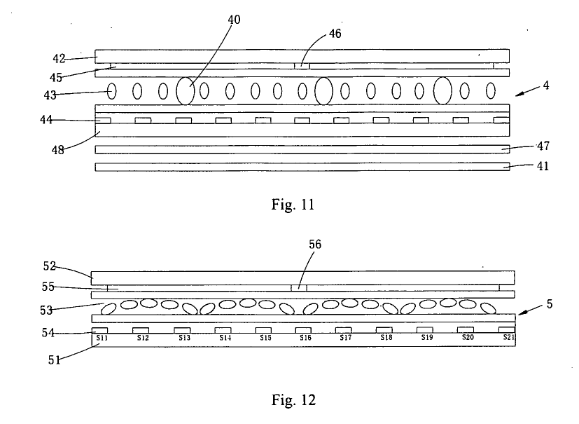

As shown in FIG. 6 and FIG. 12, since the second electrode 25 is a strip electrode, to further improve the display quality when the liquid crystal lens 2 is used for three-dimensional display, the pitch of the liquid crystal lens unit L1 is set as L, the width of the second electrode 25 is set as M, and

$$\frac{L}{2} \leq M < nL ,$$

wherein n is a natural number referring to the number of the liquid crystal lens units L1 corresponding to the second electrode 25, and n≧1. The pitch L of the liquid crystal lens unit L1 is set as the distance between the central lines of two first electrodes 24 at the edge of the liquid crystal lens unit L1. As shown in FIG. 6, when the second electrode 25 corresponds to one liquid crystal lens unit L1, namely when n is equal to 1, the width of the second electrode 25 is expressed as

$$\frac{L}{2} \leq M < L ,$$

the width of the second electrode 25 is less than the pitch of the liquid crystal lens unit L1 and can approach the pitch of the liquid crystal lens unit L1 infinitely, namely the width of the opening portion 26 can be randomly set to solve the crosstalk problem at the junction of the liquid crystal lens unit L1 and the liquid crystal lens unit L2, and an operator sets the width of the second electrode 25 according to specific conditions conveniently. The opening portion 26 formed between two adjacent second electrodes 25 is opposite to the first electrode 24 at the edge of the liquid crystal lens unit L1, thus, the electric field intensity distribution at the edges of the liquid crystal lens unit L1 and the liquid crystal lens unit L2 is optimized, the deflecting degrees of the liquid crystal molecules 23 nearby the first electrode 24 at the edge of the liquid crystal lens unit L1 are improved, the optical path difference distribution curve of the liquid crystal lens 2 represents a smoother phase retardation quantity, the crosstalk at the junction of the adjacent liquid crystal lens unit L1 and liquid crystal lens unit L2 is reduced, and the three-dimensional display effect and the viewing comfortableness are improved. Meanwhile, to ensure normal presentation of three-dimensional images when the liquid crystal lens 2 is used for three-dimensional display, the distance between the two adjacent second electrodes 25 cannot be too large, to avoid affecting the normal display of the liquid crystal lens 2.

As shown in FIG. 6, the liquid crystal lens 2 provided by this embodiment further includes a voltage control module (not shown), the voltage control module is configured to control the first driving voltage applied to the first electrode 24 at the edge of the liquid crystal lens unit L1 and the second driving voltage applied to the second electrode 25, and the potential difference between the first driving voltage and the second driving voltage is greater than the threshold voltage of the liquid crystal molecules 23. An electric field with unequal electric field intensities is produced by the potential difference, and the liquid crystal molecules 23 deflect along with the change of the electric field intensity under the action of the electric field, so that the refractive index of the liquid crystal layer between the first substrate 21 and the second substrate 22 is distributed in a gradient manner, and liquid crystal lens units L1 arranged in an array manner are formed. The magnitudes of the first driving voltage and the second driving voltage can be accurately controlled by using the voltage control module, so that when the liquid crystal lens 2 is used for three-dimensional display, the liquid crystal molecules 23 are arranged according to the specified electric field distribution and close to the ideal parabolic distribution, the liquid crystal lens units L1 with gradually-changed refractive index are formed, and the imaging effect is excellent.

As shown in FIG. 6, the potential difference provided by this embodiment is u₀, the threshold voltage of the liquid crystal molecules 23 is vₜₕ, and vₜₕ<u₀≦4vₜₕ. The voltage value of the first driving voltage is related to the width of the first electrode 24, if the width of the first electrode 24 is large, the voltage value of the corresponding first driving voltage should be small; likewise, if the width of the first electrode 24 is small, the voltage value of the corresponding first driving voltage should be large. In this way, the voltage required by imaging of the liquid crystal lens 2 is satisfied, and meanwhile, when the liquid crystal lens 2 is used for three-dimensional display, the problem of crosstalk at the junction of the adjacent liquid crystal lens unit L1 and liquid crystal lens unit L2 due to high electric field intensity nearby the first electrode 24 at the edge of the liquid crystal lens unit L1 is solved.

As shown in FIG. 5 and FIG. 6, this embodiment further provides a three-dimensional display device, including a display panel 1 and the above liquid crystal lens 2, wherein the liquid crystal lens 2 is arranged on the emergent side of the display panel 1, when the liquid crystal lens 2 is used for three-dimensional display, a first voltage is applied to the first electrode 24, an equal second voltage is applied to the second electrode 25, and a first electric field with unequal electric field intensities is formed between the first substrate 21 and the second substrate 22 by the potential difference between the first voltage and the second voltage, the first electric field drives the liquid crystal molecules 23 to deflect so as to form the liquid crystal lens unit L1 with gradually-changed refractive index, and light emitted by the display panel 1 is adjusted by the liquid crystal lens unit L1 to present three-dimensional images.

### Embodiment 2

As shown in FIG. 9, a liquid crystal lens 3 provided by the present invention roughly has the same structure as the liquid crystal lens 2 provided by embodiment 1, the difference lies in that each liquid crystal lens unit L1 corresponds to m first electrodes 34, m is a natural number, and m≧3. In this embodiment, each liquid crystal lens unit L1 corresponds to 6 first electrodes 34. For the liquid crystal lens 3 with this structure, symmetrical fourth driving voltages are applied to the first electrodes 34, specifically, in the liquid crystal lens unit L1, symmetrical voltages are applied to strip electrodes, such as S11, S12, S13, S14, S15, S16, and specifically the voltage of S11(V(S11)) is equal to the voltage of S16(V(S16)), the voltage of S12(V(S12)) is equal to the voltage of S15(V(S15)), the voltage of S13(V(S13)) is equal to the voltage of S14(V(S14)), moreover the voltage of S11(V(S11)) is larger than the voltage of S12(V(S12)), the voltage of S12(V(S12)) is larger than the voltage of Si 3(V(S13)), i.e., V(S11)=V(S16)>V(S12)=V(S15)>V(S13)=V(S14). Similarly, in the liquid crystal lens unit L2, symmetrical voltages are applied to strip electrodes, such as S16, S17,S18,S19, S3, S21, and specifically the voltage of S16(V(S16)) is equal to the voltage of S21(V(S21)), the voltage of S17(V(S17)) is equal to the voltage of S3(V(S3)), the voltage of S18(V(S18)) is equal to the voltage of S19(V(S19)), moreover the voltage of S16(V(S16)) is larger than the voltage of S17(V(S17)), the voltage of S17(V(S17)) is larger than the voltage of S18(V(S18)), i.e., V(S16)=V(S21)>V(S17)=V(S3)>V(S18)=V(S19), and a fifth driving voltage is applied to a second electrode 35. The voltages applied to the first electrodes 34 at both ends of the liquid crystal lens unit L1 are maximum, and the voltage applied to the first electrode 34 at the center of the liquid crystal lens unit L1 is minimum, namely, the voltages are gradually decreased from the both ends to the center and are distributed symmetrically. The voltages are symmetrically distributed in the liquid crystal lens unit L1, and the refractive index of liquid crystal molecules 33 presents a certain gradually-changed trend under the influence of the smooth electric field, so that the liquid crystal lens 3 can have good optical imaging property. The obtained optical path difference distribution of the liquid crystal lens unit L1 is matched with that of the standard parabolic lens through appropriate voltage matching. Thus, in the practical viewing process, crosstalk is obviously reduced, the dizziness caused by three-dimensional viewing parallax is reduced, and the three-dimensional display effect and the viewing comfortableness are improved. In this embodiment, since the liquid crystal lens unit L1 and the liquid crystal lens unit L2 have the same structure, only the liquid crystal lens unit L1 is described and the repeated description of the liquid crystal lens unit L2 is omitted, when the liquid crystal lens unit is mentioned. The description below will follow the same and will not be repeated again.

As shown in FIG. 10, in the liquid crystal lens 3 provided by this embodiment, each liquid crystal lens unit L1 corresponds to a plurality of first electrodes 34, and an opening portion 36 formed between two adjacent second electrodes 35 is opposite to the first electrode 34 at the edge of the liquid crystal lens unit L1, so that the distribution of the electric field intensity at the edge of the liquid crystal lens unit L1 is optimized, the deflecting degrees of liquid crystal molecules 33 nearby the first electrode 34 at the edge of the liquid crystal lens unit L1 are improved, the optical path difference distribution curve of the liquid crystal lens 2 presents a smoother phase retardation quantity, the crosstalk at the junction of the liquid crystal lens unit L1 and the liquid crystal lens unit L2 is obviously reduced, the three-dimensional display effect and the viewing comfortableness are improved, the optical path difference distribution at the junction of the adjacent liquid crystal lens unit L1 and liquid crystal lens unit L2 is obviously improved, and the optimized optical path difference distribution is close to an ideal parabola, and accordingly, the crosstalk produced when the three-dimensional display device adopting the liquid crystal lens 3 is used for three-dimensional display is improved, and thus the three-dimensional display effect and the viewing comfortableness are improved.

In this embodiment, the first electrodes 34 can be strip electrodes, and the widths of the first electrode 34 are equal. According to the design requirements of the liquid crystal lens 3, the operation of etching a plurality of first electrodes 34 with equal widths is convenient, similarly, a plurality of first electrodes 34 with different widths can also be etched according to the design requirements of the liquid crystal lens 3, and an operator can set the widths of the first electrodes 34 according to specific requirements.

Preferably, when the first electrodes 34 are arranged at equal intervals, the voltage control module controls the first voltages applied to the first electrodes 34, so that when the liquid crystal lens 3 is used for three-dimensional display, a lens with a regular gradient refractive index is formed to ensure the light splitting function of the liquid crystal lens 3. When the first electrodes 34 are arranged at different intervals, the voltage control module controls the first voltages applied to the first electrodes 34, so that when the liquid crystal lens 3 is used for three-dimensional display, the lens with the regular gradient refractive index is formed to ensure the light splitting function of the liquid crystal lens 3.

As shown in FIG. 9, the voltage control module provided by this embodiment is further configured to control the first voltage applied to the first electrode 34 at the edge of the liquid crystal lens unit L1 and the second voltage applied to the second electrode 35, the voltage values of the first voltages are gradually decreased from the two edges of the liquid crystal lens unit L1 to the center of the liquid crystal lens unit L1, namely, the voltage values of the first voltages applied to the first electrodes 34 at the two edges are maximum, and the voltage values are decreased in sequence. A first electric field with unequal electric field intensities is produced by the potential difference between the first voltage and the second voltage, and the liquid crystal molecules 33 deflect along with the change of the electric field intensity under the action of the electric field, so that the refractive index of the liquid crystal layer between the first substrate 21 and the second substrate 23 is distributed in a gradient manner, then liquid crystal lens units L1 arranged in an array manner are formed, and light emitted by the display panel is controlled by the liquid crystal lens units L1 so as to realize three-dimensional display.

### Embodiment 3

As shown in FIG. 11, a liquid crystal lens 4 provided by the embodiment of the present invention roughly has the same structure as the liquid crystal lens 3 provided by embodiment 2, the liquid crystal lens 4 includes a first substrate 41 and a second substrate 42 which are arranged oppositely, the second substrate 42 is arranged above the first substrate 41, liquid crystal molecules 43 and spacers 40 are arranged between the first substrate 41 and the second substrate 42, second electrodes 45 are arranged on the second substrate 42, and first electrodes 44 are arranged on the first substrate 41, and an opening portion 46 is formed between two adjacent second electrodes 45. The difference lies in that, a third electrode 47 is arranged between the first substrate 41 and the first electrodes 44, an insulating layer 48 is arranged between the third electrode 47 and the first electrodes 44, and the first electrodes 44 are arranged on the insulating layer 48. When the liquid crystal lens 4 is in 3D display, the voltage control module is further configured to control a third driving voltage applied to the third electrode 47 and a second driving voltage applied to the second electrodes 45, and the driving voltages are matched with each other to drive the liquid crystal molecules 43 to deflect, so that it is ensured that standard three-dimensional images are presented when the liquid crystal lens 4 is used for 3D display. Moreover, in this embodiment, as the second electrodes 45 are strip electrodes, and the opening portion 46 formed between two adjacent second electrodes 45 is opposite to the first electrodes 44, the distribution of the electric field intensity at the edge of the liquid crystal lens unit is optimized, the deflecting degrees of the liquid crystal molecules 43 nearby the first electrodes 44 at the edge of the liquid crystal lens unit L1 are improved, the optical path difference distribution curve of the liquid crystal lens 2 presents a smoother phase retardation quantity, the crosstalk at the edge of the liquid crystal lens unit is obviously reduced, the three-dimensional display effect and the viewing comfortableness are improved, the optical path difference distribution of the liquid crystal lens unit is obviously improved, and the optimized optical path difference distribution approaches an ideal parabola, so that the crosstalk produced when the three-dimensional display device adopting the liquid crystal lens 4 is used for three-dimensional display is improved, and thus the three-dimensional display effect and the viewing comfortableness are improved. The crosstalk at the edge of the liquid crystal lens unit is obviously reduced to improve the viewing quality. The second driving voltage is applied to the second electrodes 45, the third driving voltage is applied to the third electrode 47, and the potential difference between the second driving voltage and the third driving voltage is greater than the threshold voltage of the liquid crystal molecules 43, in this way, a second electric field with equal electric field intensity is formed between the second electrodes 45 and the third electrode 47. The second electric field enables the liquid crystal molecules 43 to deflect. The refractive index difference between the deflected liquid crystal molecules 43 and the spacers 40 is within a preset range, which is less than 0.1. And at the moment, the refractive index of the liquid crystal molecules 43 is close to that of the spacers 40. Thus, when light passes through the liquid crystal molecules 43 and the spacers 40, light is not refracted, and thus, the light spot of the spacers 40 can be perfected by the liquid crystal lens 4.

In this implementation, the third electrode 47 can be preferably set as a planar electrode, and the planar electrode refers to that a conductive material is covered on the entire surface of the first substrate 44. The third electrode 47 has a simple structure and can provide a stable third driving voltage. Thus, the second electric field with equal electric field intensity is formed between the second electrodes 45 and the third electrode 47 when the liquid crystal lens 2 is used for 2D display, the second electric field enables the liquid crystal molecules 43 to deflect, the refractive index difference between the deflected liquid crystal molecules 43 and the spacers 40 is within the preset range, which is less than 0.1. And at the moment, the refractive index of the liquid crystal molecules 43 is close to that of the spacers 40. Thus, when light passes through the liquid crystal molecules 43 and the spacers 40, light is not refracted, and thus, the light spot of the spacers 40 can be perfected by the liquid crystal lens 4.

### Embodiment 4

As shown in FIG. 12, a liquid crystal lens 5 provided by the present invention roughly has the same structure as the liquid crystal lens 2 provided by embodiment 1. The liquid crystal lens 5 provided by this embodiment includes a first substrate 51 and a second substrate 52 which are arranged oppositely, liquid crystal molecules 53 are arranged between the first substrate 51 and the second substrate 52, a plurality of first electrodes 54 are arranged on the first substrate 51, in FIG. 12, the first electrodes 54 are expressed as S11, S12, S13, S14, S15, S16, S17, S18, S19, S20, S21, the plurality of first electrodes 54 are arranged at intervals, a plurality of second electrodes 55 are arranged on one side of the second substrate 52 facing to the first substrate 51, an opening portion 56 is formed between two second electrodes 55, the opening portion 56 corresponds to the first electrode S16, the central line of the opening portion 56 and the central line of the first electrodes S16 are on the same straight line, since the opening portion 56 is provided with no conductive material, the electric field at the edge of the first liquid crystal lens unit L1 will not be changed relatively violently, so that the optical path difference herein will not be greatly fluctuated. The first electrodes 54 and the second electrodes 55 are applied with voltages respectively, and the optical path difference of the liquid crystal lens unit coincides with that of the standard parabolic lens much better. When the liquid crystal lens 5 is used for three-dimensional display, the crosstalk can be obviously reduced to improve the display quality of three-dimensional images. The electric field curve at the opening portion 56 approaches the area having a conductive material in a relatively mild state, so that the distribution of the electric field intensity at the edge of the liquid crystal lens unit is optimized, the deflecting degrees of the liquid crystal molecules 53 nearby the first electrodes 54 at the edge of the liquid crystal lens unit are improved, and a smoother phase retardation quantity is presented. In this way, the electric field change at the junction of two adjacent liquid crystal lens units L1 is improved to a certain extent and approaches the second electrodes 55 in the relatively mild state, so as to avoid the relatively great fluctuation of the optical path difference herein caused by the electric field change, obviously reduce the crosstalk at the junction of the adjacent liquid crystal lens units and improve the three-dimensional display effect and the viewing comfortableness.

In this embodiment, one second electrode 55 corresponds to two liquid crystal lens units (not shown in the figure), i.e., n is equal 2, the width of the second electrode 55 is less than twice of the pitch of the liquid crystal lens unit L1. Of course, one second electrode 55 can cover more liquid crystal lens units, i.e., n>2, the width of the second electrode 55 is expressed as

$$\frac{L}{2} \leq M < nL ,$$

not only the crosstalk problem exiting at the boundary of the liquid crystal lens unit is solved, but also the processing difficulty of the second electrodes 55 is reduced to facilitate the width setting of the second electrode 55 by the operator as required.

In this embodiment, to further improve the display quality when the liquid crystal lens 5 is used for three-dimensional display, each second electrode 55 corresponds to at least two liquid crystal lens units L1, the pitch of each liquid crystal lens unit L1 is L, and the pitch L of the liquid crystal lens unit L1 is set as the distance between the central lines of two first electrodes 54 at the edge of the liquid crystal lens units L1. The width of the second electrode 55 is M,

$$\frac{L}{2} \leq M < nL ,$$

wherein n is a natural number referring to the number of the liquid crystal lens units L1 corresponding to the second electrode 55, and n≧2. As shown in FIG. 12, one second electrode 55 corresponds to two liquid crystal lens units (not shown in the figure), i.e., n is equal to 2, and the width of the second electrode 55 is less than twice of the pitch of the liquid crystal lens unit L1. Of course, one second electrode 55 can cover more liquid crystal lens units, i.e., n>2, the width of the second electrode 55 is expressed as

$$\frac{L}{2} \leq M < nL ,$$

not only the crosstalk problem exiting at the boundary of the liquid crystal lens unit is solved, but also the processing difficulty of the second electrodes 55 is reduced to facilitate the width setting of the second electrode 55 by the operator as required. The width of the opening portion 56 can be randomly set to solve the crosstalk problem at the junction of the liquid crystal lens unit L1 and the liquid crystal lens unit L2, and the operator sets the width of the second electrode 55 according to specific conditions conveniently. The opening portion 56 formed between two adjacent second electrodes 55 is opposite to the first electrode 54 at the edge of the liquid crystal lens unit L1, so that the distribution of the electric field intensity at the edges of the liquid crystal lens unit L1 and the liquid crystal lens unit L2 is optimized, the deflecting degrees of the liquid crystal molecules 53 nearby the first electrode 54 at the edge of the liquid crystal lens unit L1 are improved, the optical path difference distribution curve of the liquid crystal lens 5 presents a smoother phase retardation quantity, the crosstalk at the junction of the adjacent liquid crystal lens unit L1 and liquid crystal lens unit L2 is reduced, and the three-dimensional display effect and the viewing comfortableness are improved. Meanwhile, to ensure normal presentation of three-dimensional images when the liquid crystal lens 5 is used for three-dimensional display, the distance between the two adjacent second electrodes 55 cannot be too large, to avoid affecting the normal display of the liquid crystal lens 5.

Of course, the technical solutions of this embodiment can also be achieved based on embodiment 2, the implementation process and the principle are basically the same, and will not be repeated redundantly herein.

The foregoing descriptions are merely preferred embodiments of the present disclosure, rather than limiting the present disclosure. Any modification, equivalent substitution, improvement and the like made within the spirit and principle of the present disclosure should be included within the protection scope of the present disclosure.

1. A liquid crystal lens, comprising a first substrate and a second substrate which are arranged oppositely, and liquid crystal molecules sandwiched between the first substrate and the second substrate, wherein the first substrate is provided with a plurality of first electrodes, the first electrodes are arranged at intervals, when the liquid crystal lens is used for three-dimensional display, a plurality of liquid crystal lens units with the same structure and distributed in an array manner are formed between the first substrate and the second substrate, and two adjacent liquid crystal lens units share one first electrode, wherein a plurality of second electrodes are arranged on one side of the second substrate facing to the first substrate, an extension direction of the second electrodes is parallel to an extension direction of the first electrodes, the second electrodes are arranged at intervals, an opening portion is formed between the two adjacent second electrodes, and a central line of the opening portion is on the same straight line as a central line of the corresponding first electrode at the edge of the liquid crystal lens unit.

2. The liquid crystal lens of claim 1, wherein a width of the opening portion is greater than a width of the corresponding first electrode at the edge of the liquid crystal lens unit.

3. The liquid crystal lens of claim 1, wherein a width of the opening portion is equal to a width of the corresponding first electrode at the edge of the liquid crystal lens unit.

4. The liquid crystal lens of claim 1, wherein a width of the opening portion is less a the width of the corresponding first electrode at the edge of the liquid crystal lens unit.

5. The liquid crystal lens of any of claim 1, wherein the first electrodes are arranged on the first substrate obliquely, and an extension direction of the first electrodes intersects with an arrangement direction of the first electrodes to form an included angle.

6. The liquid crystal lens of claim 5, wherein the included angle is α, and 60°≦α<80°.

7. The liquid crystal lens of claim 6, wherein each liquid crystal lens unit corresponds to one second electrode, a central line of the liquid crystal lens unit is on the same straight line as a central line of the second electrode, and a width of the second electrode is less than a pitch of the liquid crystal lens unit.

8. The liquid crystal lens of claim 6, wherein each second electrode corresponds to at least two liquid crystal lens units.

9. The liquid crystal lens of claim 7, wherein each liquid crystal lens unit corresponds to two first electrodes.

10. The liquid crystal lens of claim 7, wherein each liquid crystal lens unit corresponds to m first electrodes, wherein m is a natural number and m≧3.

11. The liquid crystal lens of claim 10, wherein the widths of the first electrodes are equal.

12. The liquid crystal lens of claim 11, wherein the first electrodes are arranged at equal intervals.

13. The liquid crystal lens of claim 7, wherein the first electrodes are strip electrodes, and a cross section of the first electrodes along the extension direction of the first electrodes is rectangular, arched or serrated.

14. The liquid crystal lens of claim 13, wherein the second electrodes are strip electrodes, and a cross section of the second electrodes along the extension direction of the second electrodes is rectangular, arched or serrated.

15. The liquid crystal lens of claim 14, wherein the pitch of the liquid crystal lens unit is L, the width of the second electrode is M, and
$$\frac{L}{2} \leq M < nL ,$$
wherein n is a natural number referring to the number of the liquid crystal lens units corresponding to the second electrodes, and n≧1.

16. The liquid crystal lens of claim 5, further comprising a voltage control module, configured to control a first driving voltage applied to the first electrode at the edge of the liquid crystal lens unit and a second driving voltage applied to the second electrode, wherein a potential difference between the first driving voltage and the second driving voltage is greater than a threshold voltage of the liquid crystal molecules.

17. The liquid crystal lens of claim 16, wherein the potential difference is u₀, the threshold voltage of the liquid crystal molecules is vₜₕ, and vₜₕ<u₀≦4vₜₕ.

18. The liquid crystal lens of claim 16, further comprising a third electrode arranged between the first substrate and the first electrode, wherein an insulating layer is arranged between the third electrode and the first electrode, the first electrodes are arranged on the insulating layer, and the voltage control module is further configured to control a third driving voltage applied to the third electrode.

19. The liquid crystal lens of claim 18, wherein the third electrode is a planar electrode.

20. A three-dimensional display device, comprising a display panel, as well as a liquid crystal lens, comprising a first substrate and a second substrate which are arranged oppositely, and liquid crystal molecules sandwiched between the first substrate and the second substrate, wherein the first substrate is provided with a plurality of first electrodes, the first electrodes are arranged at intervals, when the liquid crystal lens is used for three-dimensional display, a plurality of liquid crystal lens units with the same structure and distributed in an array manner are formed between the first substrate and the second substrate, and two adjacent liquid crystal lens units share one first electrode, wherein a plurality of second electrodes are arranged on one side of the second substrate facing to the first substrate, an extension direction of the second electrodes is parallel to an extension direction of the first electrodes, the second electrodes are arranged at intervals, an opening portion is formed between the two adjacent second electrodes, and a central line of the opening portion is on the same straight line as a central line of the corresponding first electrode at the edge of the liquid crystal lens unit, wherein the liquid crystal lens is arranged on an emergent side of the display panel.
